(19) United States
(12) Patent Application Publication
(10) Pub. No.: US 2011/0122640 A1
(43) Pub. Date: May 26, 2011

(54) APPARATUS FOR CONTROLLING MOVEMENT OF A LAMP UNIT RELATIVE TO AN AUTOMOBILE BODY

(75) Inventors: Yu-Chieh Wang, Tainan Hsien (TW); Jia-Jyun Jyu, Tainan City (TW); Jian-Jhih Li, Tainan County (TW)

(73) Assignee: MAXZONE VEHICHLE LIGHTING CORP., Fontana, CA (US)

(21) Appl. No.: 12/623,831

(22) Filed: Nov. 23, 2009

(51) Int. Cl. F21V 19/02

(52) U.S. Cl. 362/524

(57) ABSTRACT

An apparatus is adapted for controlling a lamp unit mounted on an automobile body, and includes a housing for housing input and output rods, and a transmission gear. The transmission gear meshes with a worm segment of the input rod such that the transmission gear is driven by the worm segment to rotate in response to rotation of the input rod. The output rod has a coupling end portion coupled to the lamp unit, and a rack segment meshing with the transmission gear such that the output rod is movable relative to the housing in response to rotation of the transmission gear, thereby driving movement of the lamp unit relative to the automobile body.

### BACKGROUND OF THE INVENTION

1. Field of the Invention

The invention relates to an apparatus for controlling movement of a lamp unit, more particularly to an apparatus for controlling movement of a lamp unit relative to an automobile body.

2. Description of the Related Art

FIGS. 1 and 2 illustrate a conventional apparatus for controlling movement of a head lamp (not shown) for an automobile. The conventional apparatus 1 includes a housing 11, an input rod 12, a transmission block 13, an output rod 14, and an angle indicating unit 15.

The input rod 12 is mounted rotatably in the housing 11, extends in a direction (A), and has an operating end portion 121 that extends out of the housing 11, and a threaded end portion 122 opposite to the operating end portion 121 in the direction (A).

The transmission block 13 is disposed movably in the housing 11, and is connected threadedly to the threaded end portion 122 of the input rod 2 such that the transmission block 13 is movable in the direction (A) relative to the input rod 12 in response to rotation of the input rod 12.

The output rod 14 is connected fixedly to the transmission block 13 so as to move with the transmission block 13. The output rod 14 has a coupling end portion 141 coupled to the head lamp. Thus, the head lamp can be driven by the output rod 14 to move in response to movement of the output rod 14, thereby varying the projection angle of rays of light emitted by the head lamp.

The angle indicating unit 15 is disposed rotatably in the housing 11, and has an annular outer surface formed with a spiral groove 151, and an indicator 152 disposed out of the housing 11 for indicating rotation of the angle indicating unit 15 that corresponds to the projection angle of rays of light emitted by the head lamp. The transmission block 13 has a driving pin 131 engaging movably the spiral groove 151 in the angle indicating unit 15 such that the angle indicating unit 15 is driven by the driving pin 131 to rotate in response to movement of the transmission block 13.

In such a configuration, since the transmission block 13 is connected threadedly to the threaded end portion 122 of the input rod 12, and has a relatively large load as a result of driving the angle indicating unit 15, movement of the transmission block 3 is relatively strenuous. Moreover, the spiral groove 151 in the angle indicating unit 15 must be accurately fabricated, thereby resulting in higher costs.

### SUMMARY OF THE INVENTION

Therefore, an object of the present invention is to provide an apparatus for controlling movement of a lamp unit relative to an automobile body that can be easily assembled and that can be manufactured at a relatively low cost.

According to the present invention, there is provided an apparatus for controlling movement of a lamp unit that is mounted movably on an automobile body. The apparatus comprises:

a housing;

an input rod mounted rotatably in the housing, and having an operating end portion that extends out of the housing, and a worm segment distal from the operating end portion;

a transmission gear mounted rotatably in the housing, and meshing with the worm segment such that the transmission gear is driven by the worm segment of the input rod to rotate in response to rotation of the input rod; and

an output rod mounted movably in the housing, and having a coupling end portion that extends out of the housing and that is adapted to be coupled to the lamp unit, and a rack segment meshing with the transmission gear such that the output rod is movable relative to the housing in response to rotation of the transmission gear, thereby driving movement of the lamp unit relative to the automobile body.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a conventional apparatus for controlling movement of a head lamp for an automobile;

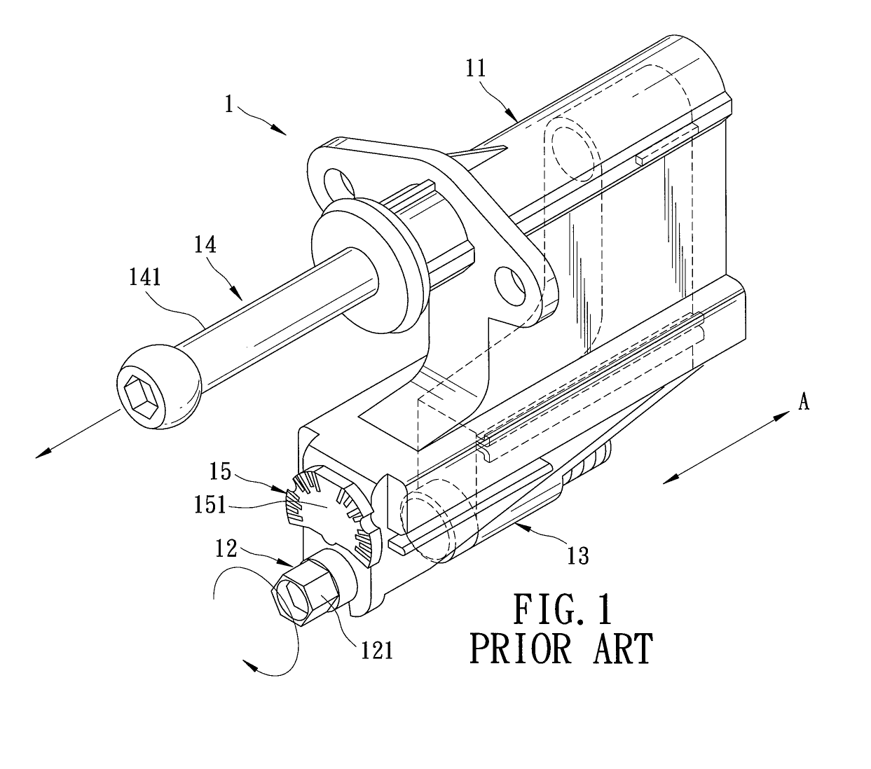

FIG. 2 is a fragmentary schematic sectional view of the conventional apparatus;

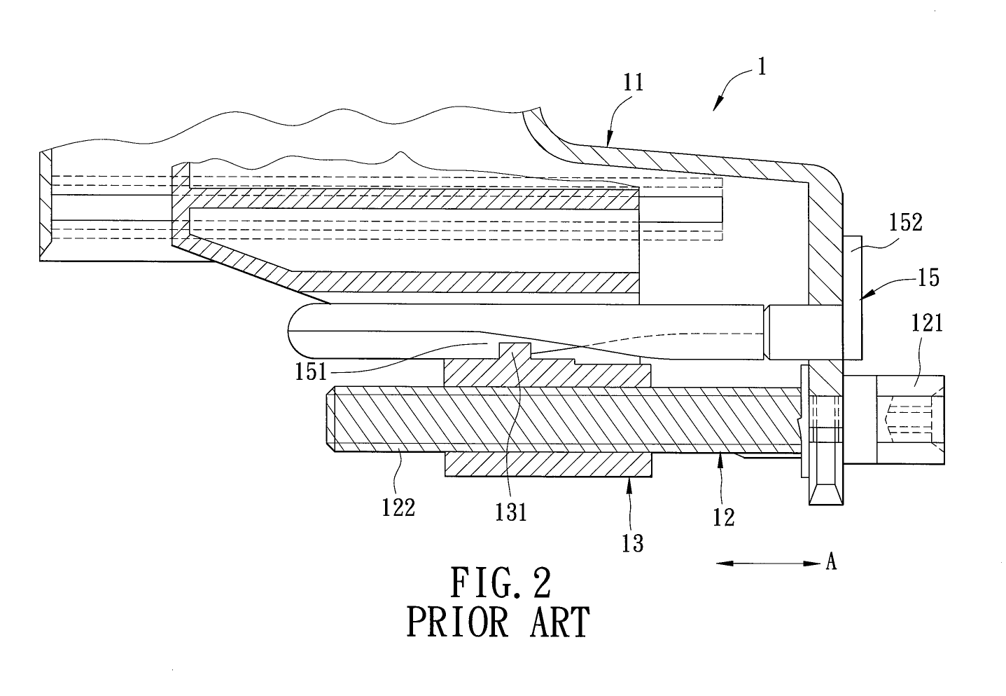

FIG. 3 is a schematic side view showing the preferred embodiment of an apparatus for controlling movement of a lamp unit on an automobile body according to the present invention;

FIG. 4 is an exploded perspective view showing the preferred embodiment;

FIG. 5 is an assembled perspective view showing the preferred embodiment without a casing part; and

FIG. 6 is a schematic sectional view showing the preferred embodiment.

### DETAILED DESCRIPTION OF THE PREFERRED EMBODIMENT

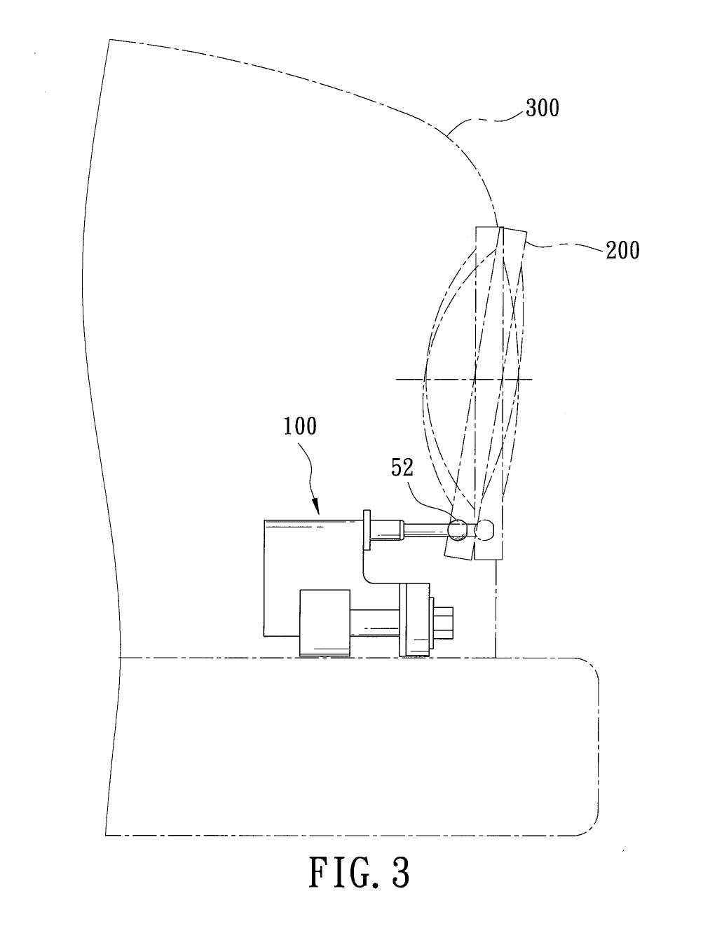

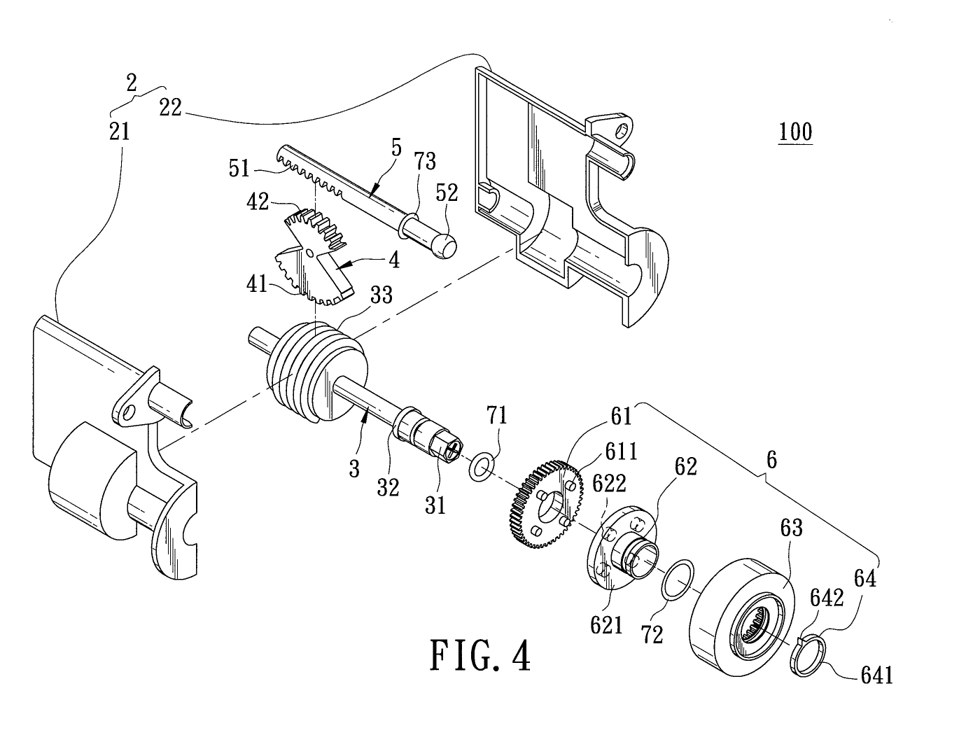

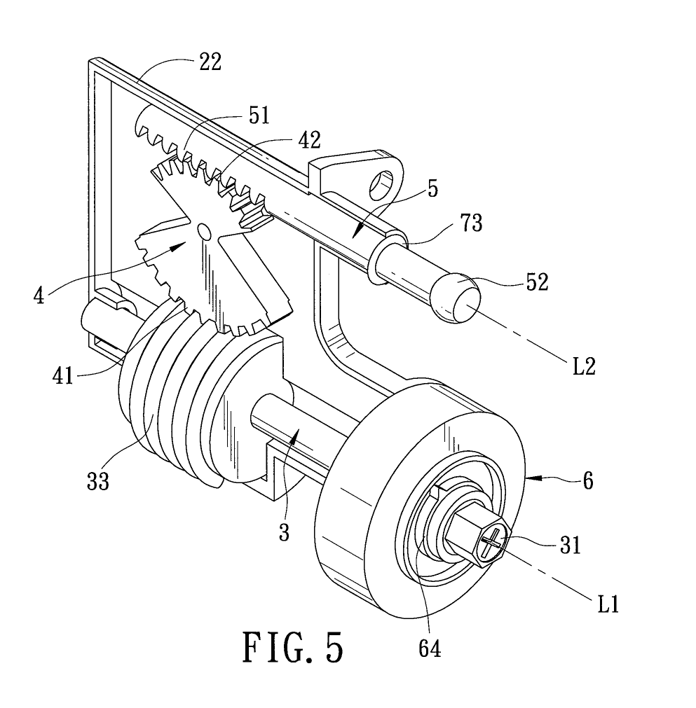

Referring to FIGS. 3 to 6, the preferred embodiment of an apparatus for controlling a lamp unit 8, such as a head lamp, that is mounted movably on an automobile body 9 according to the present invention is shown to include a housing 2, an input rod 3, a transmission gear 4, an output rod 5, an angle indicating unit 6, and first, second and third sealing rings 71, 72, 73.

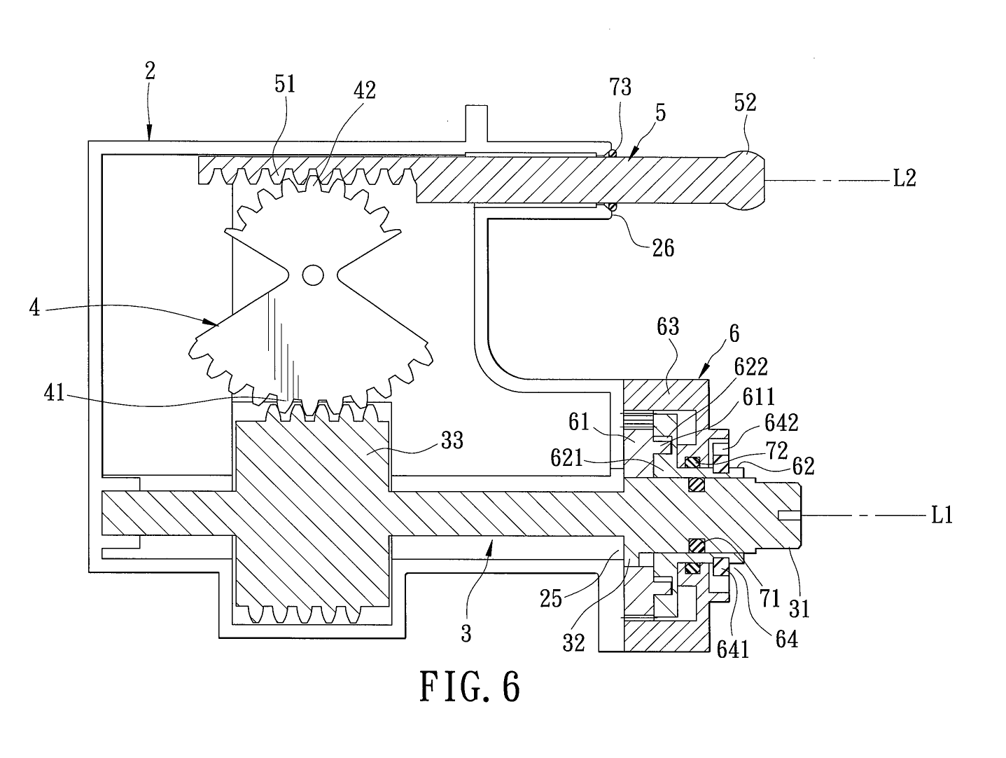

In this embodiment, the housing 2 is composed of two casing parts 21, 22 connected to each other and defining an inner receiving space 23, and first and second openings 25, 26 (see FIG. 6) therebetween. The first and second openings 25, 26 are in spatial communication with the inner receiving space 23.

The input rod 3 is mounted in the housing 2, and is rotatable relative to the housing 2 about a first axis (L1). The input rod 3 has an operating end portion 31 that extends out of the housing 2 through the first opening 25, a worm segment 33 distal from the operating end portion 31, and an eccentric wheel 32 disposed out of the housing 2 and adjacent to the operating end portion 31. In use, when the operating end portion 31 is operated to rotate using a tool (not shown), such as a wrench and a screw driver, the input rod 3 rotates, thereby resulting in eccentric rotation of the eccentric wheel 32.

The transmission gear 4 is mounted rotatably in the inner receiving space 23 in the housing 2, and meshes with the worm segment 32 of the input rod 3 such that the transmission gear 4 is driven by the worm segment 33 of the input rod 3 to rotate in response to rotation of the input rod 3. In this embodiment, the transmission gear 4 is a dual sector gear, thereby having relatively low costs, and includes a first teeth segment 41 meshing with the worm segment 33 of the input rod 3, and a second teeth segment 42.

The output rod 5 is mounted movably in the housing 2, and has a coupling end portion 52 that extends out of the housing 2 through the second opening 26 and that is adapted to be coupled to the lamp unit 8 (see FIG. 3), and a rack segment 51 meshing with the second teeth segment 42 of the transmission gear 4 such that the output rod 5 is movable relative to the housing 2 along a second axis (L2) parallel to the first axis (L1) in response to rotation of the transmission gear 4, thereby driving movement of the lamp unit 8 relative to the automobile body 9.

The angle indicating unit 6 includes a planet gear 61, a ring gear 63, a sleeve body 62 and an indicator 64. The planet gear 61 is sleeved fittingly on and engages the eccentric wheel 32 of the input rod 3 such that the planet gear 61 co-rotates with the eccentric wheel 32 of the input rod 3 in response to rotation of the input rod 3. In this embodiment, the planet gear 61 has a plurality of connecting posts 611. The ring gear 63 is fixed to the housing 2, is disposed around the operating end portion 31 of the input rod 3, and meshes with the planet gear 61, as shown in FIG. 6. The sleeve body 62 is sleeved rotatably on the operating end portion 31 of the input rod 3, and is connected to the planet gear 61 such that the sleeve body 62 is driven by the planet gear 61 to rotate in response to movement of the planet gear 61. In this embodiment, the sleeve body 62 has a rim flange 621 formed with a plurality of holes 622, each permitting extension of a corresponding one of the connecting posts 611 thereinto. It is noted that each connecting post 611 has a diameter smaller than that of the holes 622 such that each connecting post 611 is movable in a corresponding hole 622. The indicator 64 is connected to and is movable with the sleeve body 62 for indicating rotation of the sleeve body 62 that corresponds to the projection angle of rays of light emitted by the lamp unit 8. In this embodiment, the indicator 64 has a ring body 641 sleeved fixedly on the sleeve body 62, and a triangular protrusion 642 projecting from an outer periphery of the ring body 641.

As shown in FIG. 6, the first sealing ring 71 is sleeved on the operating end portion 31 of the input rod 3, and is disposed sealingly between the operating end portion 31 of the input rod 3 and the sleeve body 62 of the angle indicating unit 6. The second sealing ring 72 is sleeved on the sleeve body 62 of the angle indicating unit 6, and is disposed sealingly between the sleeve body 62 and the ring gear 63. The third sealing ring 73 is sleeved on the output rod 5, and disposed sealingly in the second opening 26 in the housing 2 for sealing the second opening 26.

In sum, the apparatus of the present invention utilizes rotation of the input rod 3 that is transmitted to the output rod 5 through the transmission gear 4 so as to drive linear movement of the output rod 5. Therefore, since the apparatus of the present invention has a relatively simple structure, the apparatus can be fabricated at relatively low costs, and can be easily assembled and operated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An apparatus for controlling movement of a lamp unit that is mounted movably on an automobile body, said apparatus comprising:
a housing;
an input rod mounted rotatably in said housing, and having an operating end portion that extends out of said housing, and a worm segment distal from said operating end portion;
a transmission gear mounted rotatably in said housing, and meshing with said worm segment such that said transmission gear is driven by said worm segment of said input rod to rotate in response to rotation of said input rod; and
an output rod mounted movably in said housing, and having a coupling end portion that extends out of said housing and that is adapted to be coupled to the lamp unit, and a rack segment meshing with said transmission gear such that said output rod is movable relative to said housing in response to rotation of said transmission gear, thereby driving movement of the lamp unit relative to the automobile body.

2. The apparatus as claimed in claim 1, wherein said transmission gear is a dual sector gear, and includes a first teeth segment meshing with said worm segment of said input rod, and a second teeth segment meshing with said rack segment of said output rod.

3. The apparatus as claimed in claim 1, wherein said input rod further has an eccentric wheel disposed adjacent to said operating end portion, said apparatus further comprising an angle indicating unit that includes
a planet gear sleeved fittingly on and engaging said eccentric wheel of said input rod such that said planet gear co-rotates with said planet gear,
a ring gear mounted fixedly to said housing, disposed around said operating end portion of said input rod and meshing with said planet gear,
a sleeve body sleeved rotatably on said operating end portion of said input rod and connected to said planet gear such that said sleeve body is driven by said planet gear to rotate in response to movement of said planet gear, and
an indicator connected to and movable with said sleeve body for indicating rotation of said sleeve body.

4. The apparatus as claimed in claim 3, wherein:
said sleeve body has a rim flange formed with a plurality of holes; and
said planet gear has a plurality of connecting posts each extending into a corresponding one of said holes in said sleeve body and having a diameter smaller than that of said holes in said sleeve body such that each of said connecting posts is movable in the corresponding one of said holes in said sleeve body.

5. The apparatus as claimed in claim 1, wherein said housing is formed with a first opening for permitting extension of said operating end portion of said input rod therethrough, and a second opening for permitting extension of said coupling end portion of said output rod therethrough, said apparatus further comprising:
a first sealing ring sleeved on said operating end portion of said input rod and disposed sealingly between said operating end portion of said input rod and said sleeve body of said angle indicating unit;
a second sealing ring sleeved on said sleeve body of said angle indicating unit and disposed sealingly between said sleeve body and said ring gear; and
a third sealing ring sleeved on said output rod and disposed sealingly in said second opening in said housing for sealing said second opening.

6. The apparatus as claimed in claim 1, wherein said input rod is rotatable relative to said housing about a first axis, said output rod being movable relative to said housing along a second axis parallel to the first axis.
